(19) United States
(12) Patent Application Publication
(10) Pub. No.: US 2023/0082229 A1
(43) Pub. Date: Mar. 16, 2023

(54) METHOD, APPARATUS AND NON-TRANSITORY COMPUTER READABLE MEDIUM FOR DETERMINING ACONTEXTUAL THRESHOLD

(71) Applicant: NEC Corporation, Minato-ku, Tokyo (JP)

(72) Inventors: Hui Lam ONG, Singapore (SG); Wei Jian PEH, Singapore (SG); Qinyu HUANG, Singapore (SG); Satoshi YAMAZAKI, Singapore (SG)

(73) Assignee: NEC Corporation, Minato-ku, Tokyo (JP)

(21) Appl. No.: 17/801,866

(22) PCT Filed: Mar. 22, 2021
(86) PCT No.: PCT/JP2021/011694

§ 371 Date: Aug. 24, 2022

(30) Foreign Application Priority Data
Mar. 23, 2020 (SG) 10202002676S

(51) Int. Cl. G06V 20/52; G06V 40/16; G06V 40/20

(52) U.S. Cl. CPC G06V 20/52; G06V 40/172; G06V 40/23; G06V 40/174

(57) ABSTRACT

According to the first aspect, there is a method for determining a contextual threshold, the contextual threshold indicating a likelihood of connection between a first subject and a second subject, the method comprising identifying an image of the first subject and the second subject in a frame within which the first subject and the second subject appear; identifying multi-dimensional information relating to the first subject and the second subject based on the identified image; and determining the contextual threshold based on the identified multi-dimensional information relating to the first subject and the second subject.

### TECHNICAL FIELD

The present invention relates broadly, but not exclusively, to methods for determining a contextual threshold, the contextual threshold indicating a likelihood of connection between a first subject and a second subject.

### BACKGROUND ART

Face recognition system are getting more and more popular as the availability of open source algorithms as well as affordable hard ware. Face recognition technologies are often used in video surveillance system for real-time security monitoring as well as post incident investigation.

Associates discovery using co-appearance detection is one of the important features in post investigation, as it helps to discover the connection of the person of interest which might lead to new direction of investigation. This is especially so when there are a plurality of subjects in a single frame.

### SUMMARY OF INVENTION

### Technical Problem

A need therefore exists to provide methods for determining a contextual threshold, the contextual threshold indicating a likelihood of connection between a first subject and a second subject that addresses one or more of the above problems.

Furthermore, other desirable features and characteristics will become apparent from the subsequent detailed description and the appended claims, taken in conjunction with the accompanying drawings and this background of the disclosure.

### Solution to Problem

According to the first aspect, there is a method for determining a contextual threshold, the contextual threshold indicating a likelihood of connection between a first subject and a second subject, the method comprising identifying image of the first subject and the second subject in a frame within which the first subject and the second subject appear; identifying multi-dimensional information relating to the first subject and the second subject based on the identified image; and determining the contextual threshold based on the identified multi-dimensional information relating to the first subject and the second subject.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a block diagram of a system within which a contextual threshold may be determined.

FIG. 2 shows a flowchart illustrating a method for determining a contextual threshold in accordance with embodiments of the invention.

FIG. 3A shows an example as to how to identify an image of the first subject and the second subject in accordance with embodiments of the present inventions.

FIG. 3B shows an example as to how to identify an image of the first subject and the second subject in accordance with embodiments of the present inventions.

FIG. 4A shows an example as to how to determine a contextual threshold based on different threshold parameters in accordance with embodiments of the present inventions.

FIG. 4B shows an example as to how to determine a contextual threshold based on different threshold parameters in accordance with embodiments of the present inventions.

FIG. 4C shows an example as to how to determine a contextual threshold based on different threshold parameters in accordance with embodiments of the present inventions.

FIG. 4D shows an example as to how to determine a contextual threshold based on different threshold parameters in accordance with embodiments of the present inventions.

FIG. 4E shows an example as to how to determine a contextual threshold based on different threshold parameters in accordance with embodiments of the present inventions.

FIG. 5 shows a flowchart illustrating a method for determining a contextual threshold in accordance with embodiments of the invention.

FIG. 6 shows an exemplary computing device that may be used to execute the method of FIGS. 2 and 5.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present invention relate to methods and apparatuses for determining a contextual threshold. The contextual threshold indicates a likelihood of connection between a first subject and a second subject.

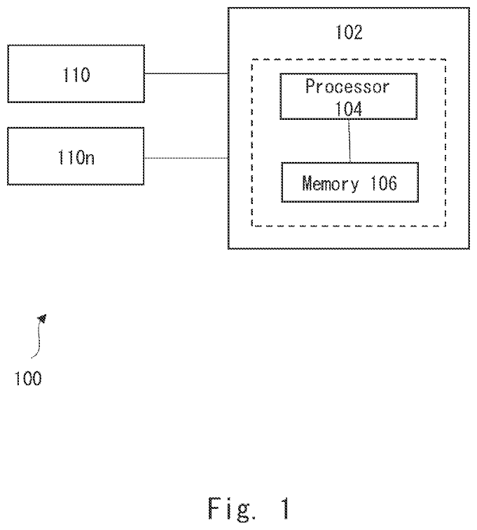

FIG. 1 shows a block diagram of a system within which a contextual threshold may be determined. Referring to FIG. 1, the process involves an apparatus 102 that is operationally coupled to at least one image capturing device 110. Each image capturing device 110 is configured to capture and send at least an image of the subject (e.g., the first subject and the second subject) at a location. In the image, a plurality of subjects may be present, including the first subject and the second subject. The image capturing device 110 may be, among other things, include a face detection system, a video capturing device, a camera and a motion sensor. The apparatus 102 is configured to receive the image of the subject.

The image capturing device 110 is capable of wireless communication using a suitable protocol with the apparatus 102. For example, embodiments may be implemented using image capturing devices 110 that are capable of communicating with WiFi/Bluetooth-enabled apparatus 102. It will be appreciated by a person skilled in the art that depending on the wireless communication protocol used, appropriate handshaking procedures may need to be carried out to establish communication between the image capturing devices 110 and the apparatus 102. For example, in the case of Bluetooth communication, discovery and pairing of the image capturing device 110 and the apparatus 102 may be carried out to establish communication.

In an example, an image of a subject is captured (or detected) at the image capturing device 110 at a predetermined frames per second (or fps). The image of the subject may be captured as the subject moves in a region and a plurality of images will be captured, determining on the fps of the image capturing device 110. If the image capturing device 110 has a fps of 5, 5 frames of the target subject will be captured within 1 second and transmitted to the apparatus 102. For various reasons, the captured images may not be transmitted to the apparatus 102 in a chronological manner in which successive images that are taken during a time period are sent in a successive way.

The apparatus 102 may include a processor 104 and a memory 106. In embodiments of the disclosure, the memory 106 and the computer program code, with processor 104, are configured to cause the apparatus 102 to identify image of the first subject and the second subject in a frame within which the first subject and the second subject appear; identify multi-dimensional information relating to the first subject and the second subject based on the identified image; and determine the contextual threshold based on the identified multi-dimensional information relating to the first subject and the second subject. In a frame within which images of a plurality of subjects may be captured, it may be difficult to determine which two subjects may be more closely related for purposes of establishing a more accurate video surveillance.

The apparatus 102 may be a server. In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

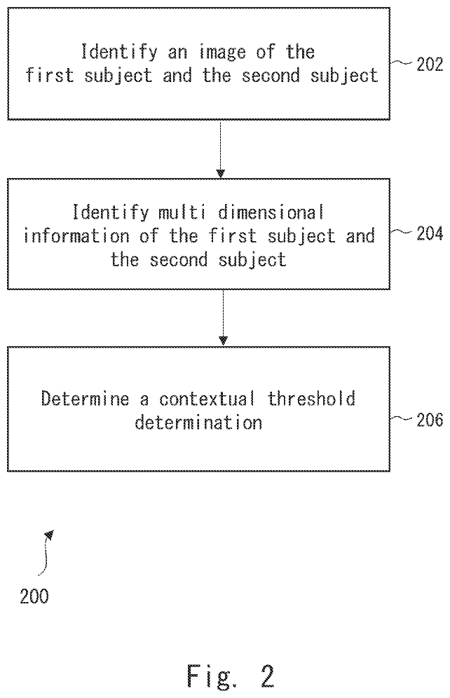

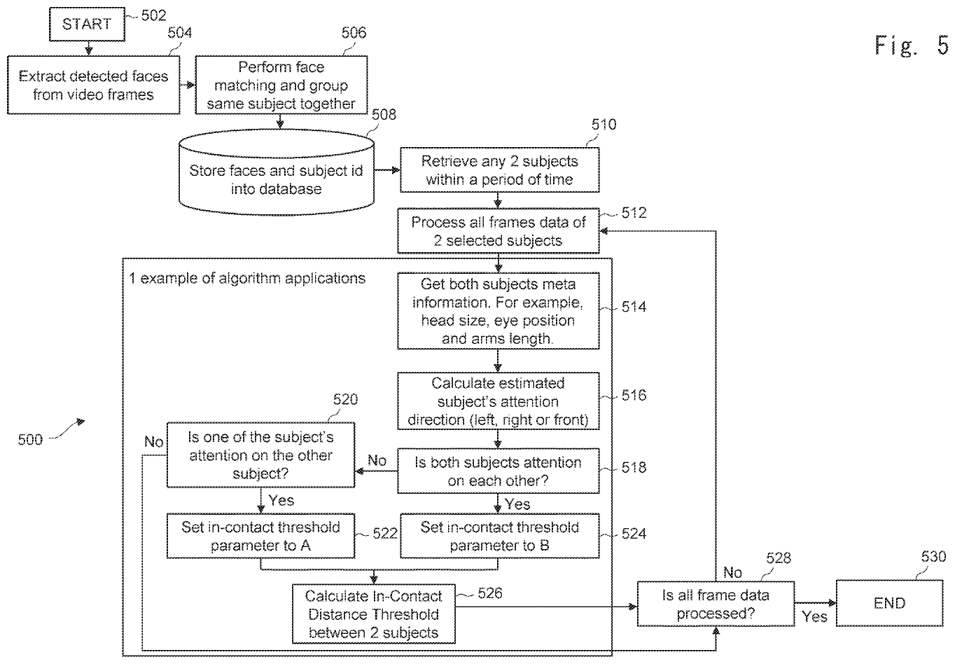

Such a server may be used to implement the method 200 shown in FIG. 2 and FIG. 5. FIG. 2 shows a flowchart illustrating a method 200 for determining a contextual threshold in accordance with embodiments of the invention.

The method 200 broadly includes:

step 202: identifying, by a processor, an image of the first subject and the second subject in a frame within which the first subject and the second subject appear.

step 204: identifying, by the processor, multi-dimensional information relating to the first subject and the second subject based on the identified image.

step 206: determining, by the processor, the contextual threshold based on the identified multi-dimensional information relating to the first subject and the second subject, the contextual threshold indicating a likelihood of connection between a first subject and a second subject.

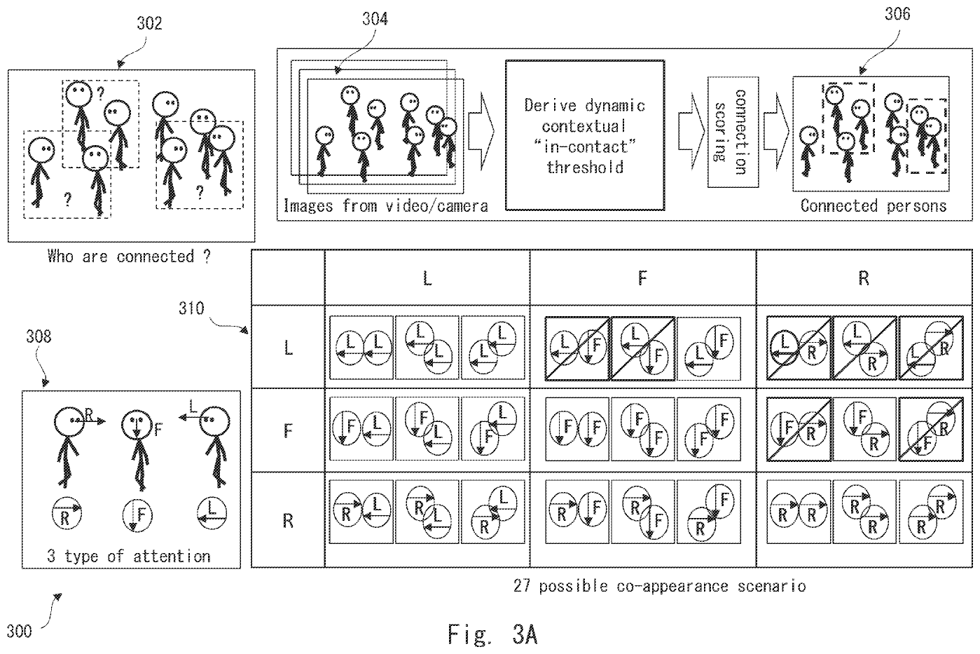

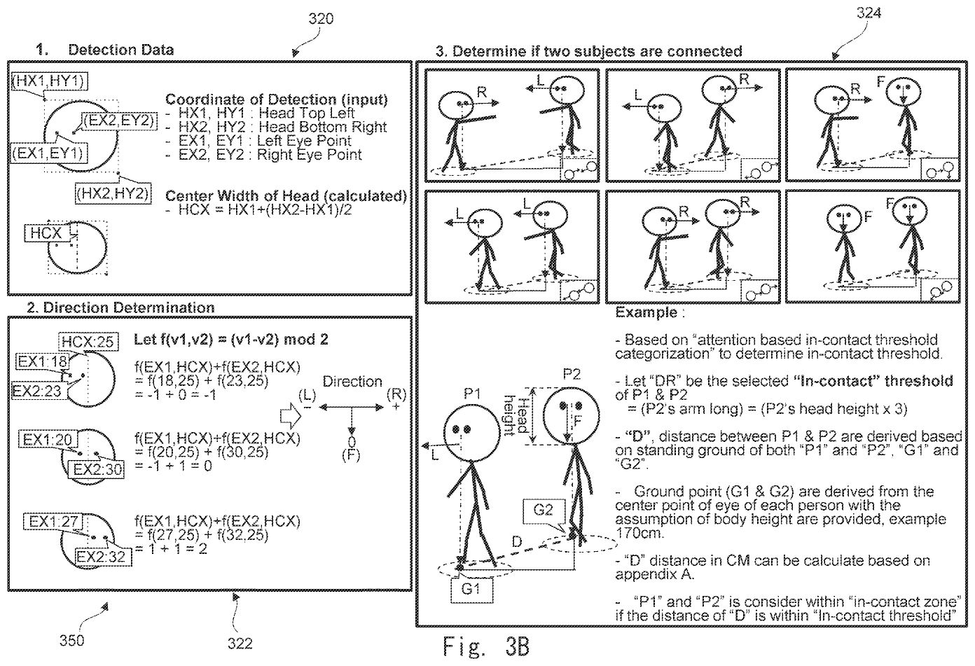

FIGS. 3A-3B show an example as to how to identify images of the first subject and the second subject in accordance with embodiments of the present inventions. This may be similar to or part of step 202 of method 200 shown in FIG. 2.

As illustrated in FIG. 3A, there is a frame 302 within which other subjects may appear together with the subject (or the first target). In order to determine which subject is more likely to be connected to the first subject, the head direction of the each subject may be determined in order to do so. For example, in the present frame, the head direction of the first subject is towards left and the head direction of another subject is towards right. Scenarios, in which the in-contact threshold is set to 0, are crossed out in in 310.

As illustrated in FIG. 3A, subjects shown in frame 304 are processed and contextual thresholds are determined which are then used to determine which subjects are connected as shown in frame 306.

FIG. 3B shows an example as to how to identify an image of the first subject and the second subject in accordance with an embodiment.

As shown in 320, coordinates of detection for a subject may be processed as inputs. For example, as shown in 320, the co-ordinates may relate to head and eyes of a subject:
HX1, HY1: Head Top Left
HX2, HY2: Head Bottom Right
EX1, EY1: Left Eye Point
EX2, EY2: Right Eye Point

Based on these co-ordinates, centre width of head of the subject may be calculated based on the following:

HCX=HX1+(HX2−HX1)/2

In 322, it shows how direction of a subject may be determined. This could be based on a function, f(v1,v2)=(v1−v2) mod 2.

If it is determined that the both left eye point and right eye point are on the left of the center width of head, the following function may be carried out:

$$f ( EX 1 , HCX ) + f ( EX 2 , HCX ) \\ = f ( 18 , 25 ) + f ( 23 , 25 ) \\ = - 1 + 0 = - 1$$

If it is determined that the both left eye point and right eye point are on the left and right of the center width of head respectively, the following function may be carried out:

$$f ( EX 1 , HCX ) + f ( EX 2 , HCX ) \\ = f ( 20 , 25 ) + f ( 30 , 25 ) \\ = - 1 + 1 = 0$$

If it is determined that the both left eye point and right eye point are on the right of the center width of head, the following function may be carried out:

$$f ( EX 1 , HCX ) + f ( EX 2 , HCX ) \\ = f ( 27 , 25 ) + f ( 32 , 25 ) \\ = 1 + 1 = 2$$

In 324, it shows how head direction of the subjects may be used to determine if two subjects are connected. In the disclosure below, more information will be provided to show how head directions of the subjects together with other information like head height and in-contact threshold.

Let “DR” be the selected in-contact threshold of the first subject P1 and the second subject P2:
DR=(P2's arm long)=(P2's head height×3)

Let “D” be the distance between P1 and P2 and is derived based on standing ground of the first subject G1 and the standing ground of the second subject G2.

Both ground points (G1 & G2) are derived from the center point of eye of each person with the assumption of body height are provided, example 170 cm.

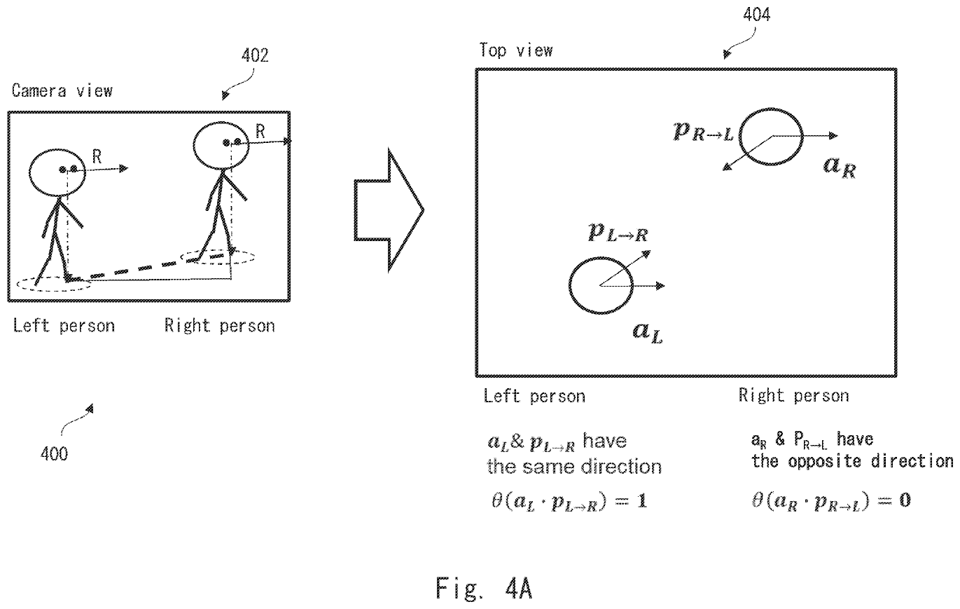

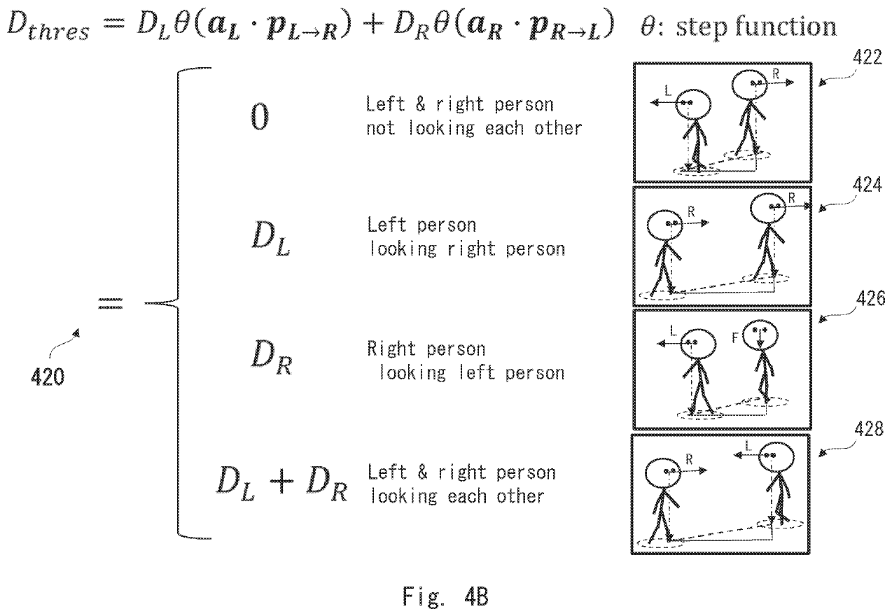

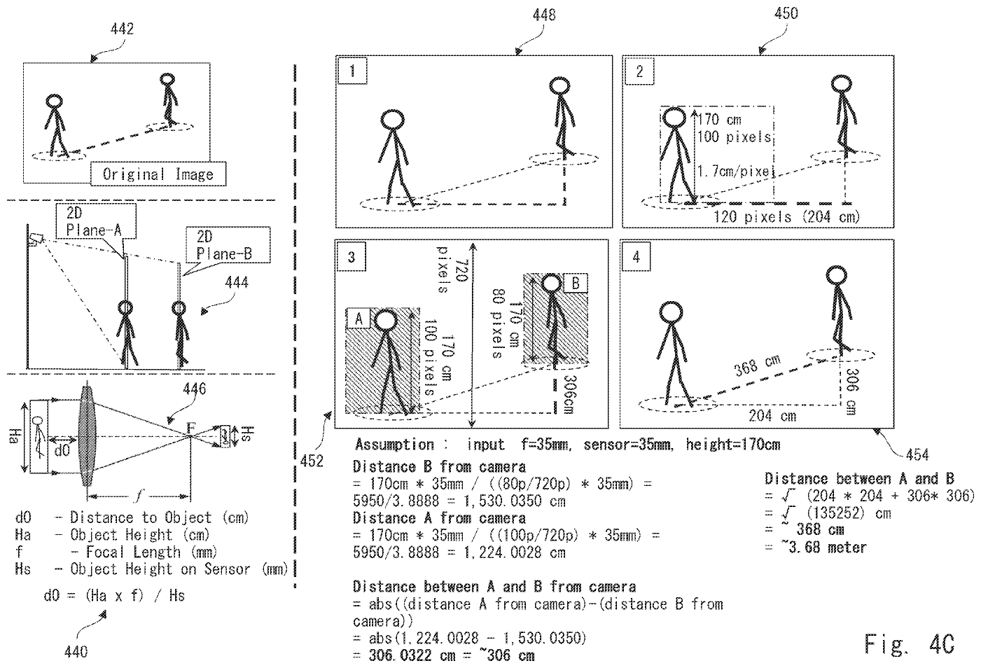

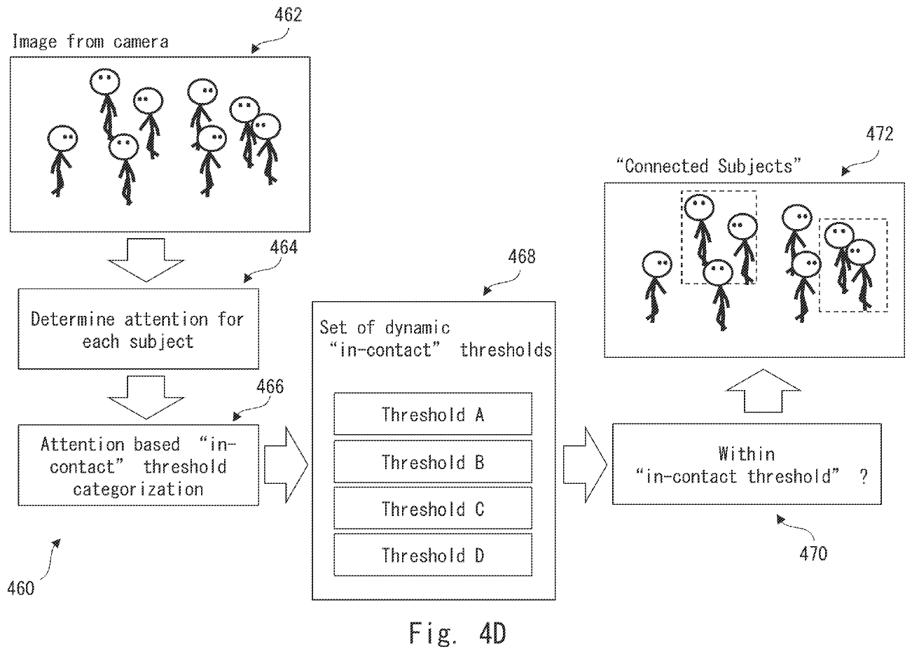

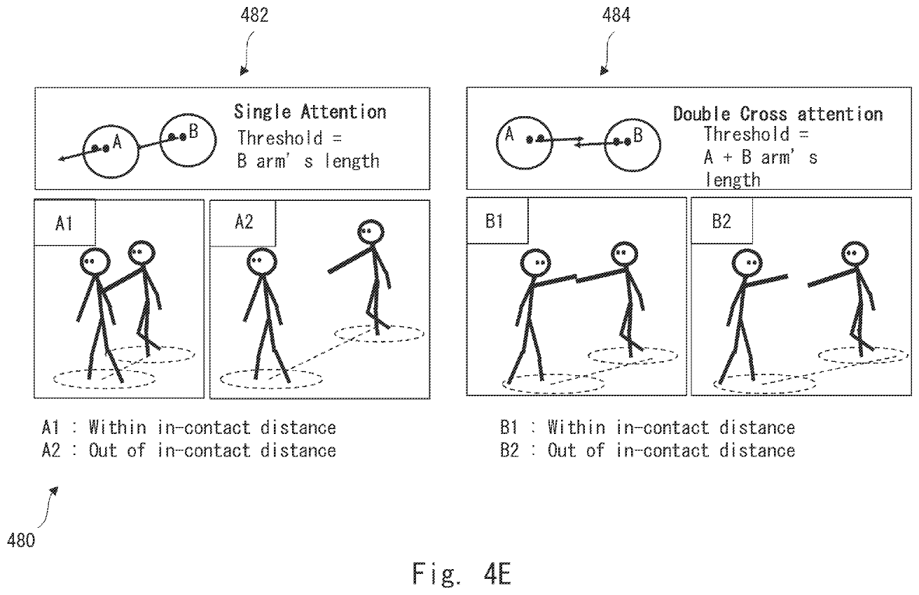

FIGS. 4A-4E show an example as to how to determine a contextual threshold based on different threshold parameters in accordance with embodiments of the present inventions.

402 shows a camera view of frame in which two subjects appear. Both subjects have their head direction facing the right based on 402 shown in FIG. 4A. 404 shows a topographical view of the frame in which the two subjects appear. One subject may have the a_{L} and P_{L→R} in the same direction and the step function of the dot product of these parameters would be 1. Another subject may have a_{L} and P_{R→L} in the opposite direction and the step function of these parameters would be 0, where a_{L} is the attention direction of the person on the left, a_{R} is the attention direction of the person on the right, P_{R→L} is the direction pointing form the person on the right to the person on the left and P_{L→R} is the direction pointing form the person on the left to the person on the right.

FIG. 4B shows an example as to how to determine a distance threshold based the parameters determined in FIG. 4A in accordance with embodiments of the present inventions based on a function as shown below:

Dₜₕᵣₑₛ=D_{L}θ(a_{L}·p_{L→R})+D_{R}θ(a_{R}·p_{R→L})

The result of the above function will be 0 if the first subject and the second subject are not looking at each other as shown in 422.

The result of the above function will be D_{L} if the subject on the left is looking at the other subject and not the other way around as shown in 424.

The result of the above function will be D_{R} if the subject on the right is looking at the other subject and not the other way around as shown in 426.

The result of the above function will be D_{L}+D_{R} if the subject on the right is looking at the other subject and the other way around (e.g., the subject on the left is looking at the other subject) as shown in 428.

FIG. 4C shows an example as to how to calculate a distance between two subjects based on camera parameters and subject height assumption. An image showing two subjects is shown in 442. The image may be taken by an image capturing device having the following assumption, focal length of 35 mm, sensor being 35 mm, height of subject being 170 cm. The number of pixels in a plane and the height of the subject may be used to calculate a parameter of cm/pixel, as shown in 450.

As shown in 452, the distance of subject B may be calculated as
=170 cm*35 mm/((80p/720p)*35 mm)=5950/3.8888=1,530.0350 cm

As shown in 452, the distance of subject A may be calculated as
=(170 cm*35 mm/((100p/720p)*35 mm)=5950/4.8611=1,224.0028 cm

Based on the calculated outcomes of the distances of subject A and B, the distance between subject A and B may be determined as:

$$= abs ( ( distance A from camera ) - ( distance B from camera ) ) \\ = abs ( 1 , 224.0028 - 1 , 530.035 ) \\ = 306.0322 cm = \sim 306 cm$$

Based on the camera parameters, the distance between subject A and B may be determined as the following, as shown in 454:

$$= √ ( 204 * 204 + 306 * 306 ) \\ = √ ( 135252 ) \\ = \sim 368 cm \\ = \sim 3.68 meter$$

FIG. 4D shows an example as to how to determine how subjects in a frame are connected in accordance with embodiments of the present inventions.

In step 462, an image may be received showing a plurality of subjects in a frame. The plurality of subjects includes a subject. In step 464, multi-dimensional information may be used to determine attention for each subject. In step 466, attention-based in-contact threshold categorization may be carried out. In step 468, a set of dynamic “in-contact” thresholds (namely, Threshold A, Threshold B, Threshold C, and Threshold D) for each subject pair is determined. In step 470, it is determined whether the set of dynamic “in-contact” thresholds are within “in-contact threshold”. In step 472, it is then determined if the subjects are connected based on the determination done in step 470.

FIG. 4E shows examples of in-contact and out of in-contact distances. In 482, one of the two subjects is facing the other subject and not the other way around. The threshold would be one arm length (e.g. arm length of subject B who has the attention direction towards subject A). In A1, the distance of subject A is within the arm length of subject B, hence it is an illustration of a within in-contact distance. In A2, the distance of subject A is not within the arm length of subject B, hence it is an illustration of out of in-contact distance. In 484, there is double-cross attention which is both subjects are having the attention direction towards each other. The threshold would be two arm lengths (e.g. arm length of subject B who has the attention direction towards subject A and arm length of subject A who has the attention direction towards subject B). In B1, the distance of subject A is within the combination of arm length of subject A and subject B, hence it is an illustration of a within in-contact distance. In B2, the distance of subject A is not within the combination of arm length of subject A and subject B, hence it is an illustration of out of in-contact distance.

FIG. 5 shows a flowchart illustrating a method for determining a contextual threshold in accordance with embodiments of the invention.

In step 502, the method starts and proceeds to step 504 to extract images of subjects from video frames. This may be obtained using the apparatus 102 mentioned in FIG. 1.

In step 506, face matching techniques may be carried out to identify individual subjects including the subject (or the first subject), and other individuals.

Individuals which are identified to be the same or having a high likelihood to relate to the same person will be grouped together.

In step 508, the outputs of step 506 are stored in a database. The database may be integral to the apparatus or separate to the apparatus mentioned in FIG. 1. A corresponding identifier identifying each subject is stored alongside with each output.

In step 510, images relating to two subjects within a period of time may be retrieved. This may relate to step 202 of FIG. 2 in which image of the first subject (or the target subject) and the second subject are identified, the images being from a frame within which the first subject and the second subject appear.

In step 512, all frames including images of the selected subjects will be processed in accordance with step 510. This step is carried out when there is more than one other subject in the frame, apart from the target subject (or the first target).

In step 514, attribute information relating to the two subjects are retrieved. The attribute information may also be known as meta information. This includes head size, eye position and length of an arm of each of the first subject and the second subject. This step could be similar to step 204 in which multi-dimensional information relating to the first subject and the second subject based on the identified image is identified.

In step 516, multi-dimensional information relating to the relating to the first subject and the second subject may be retrieved. This includes estimating an attention direction (e.g., left, right, or centre) of each of the first subject and the second subject. This may be similar to or part of step 204 in which multi-dimensional information relating to the first subject and the second subject based on the identified image is identified.

In step 518, it is determined whether or not the attention of the first subject and the second subject is towards each other. This step is carried out in response to step 516, after the attention direction of the first subject and the second subject is determined.

If it is determined that the attention of the first subject and the second subject is towards each other, step 524 is carried and an in-contact threshold parameter is set to B. The in-contact threshold parameter is one that may be used to determine the contextual threshold and is indicative of a distance between the first subject and the second subject. In an embodiment, B may be two arms length.

If it is determined that the attention of the first subject and the second subject is not towards each other, step 520 is carried and it is determined if at least one of the first subject and the second subject is towards the other one of the first subject and the second subject. If it is determined that at least one of the first subject and the second subject is towards the other one of the first subject and the second subject, step 522 is carried out and an in-contact threshold parameter is set to A. The in-contact threshold parameter is one that may be used to determine the contextual threshold and is indicative of a distance between the first subject and the second subject. In an embodiment, A may be one arms length.

In step 526, the contextual threshold based on the in-contact threshold parameter calculated in step 522 and 524 is determined. The contextual threshold indicating a likelihood of connection between a first subject and a second subject. This may be similar to or part of step 206 in which the contextual threshold is determined based on the identified multi-dimensional information relating to the first subject and the second subject.

In step 528, it is determined if all frame data is processed. If it is determined that all frame data is processed, the method proceeds to step 530 and ends. If is determined that not all frame data is processed, the method proceeds to step 512.

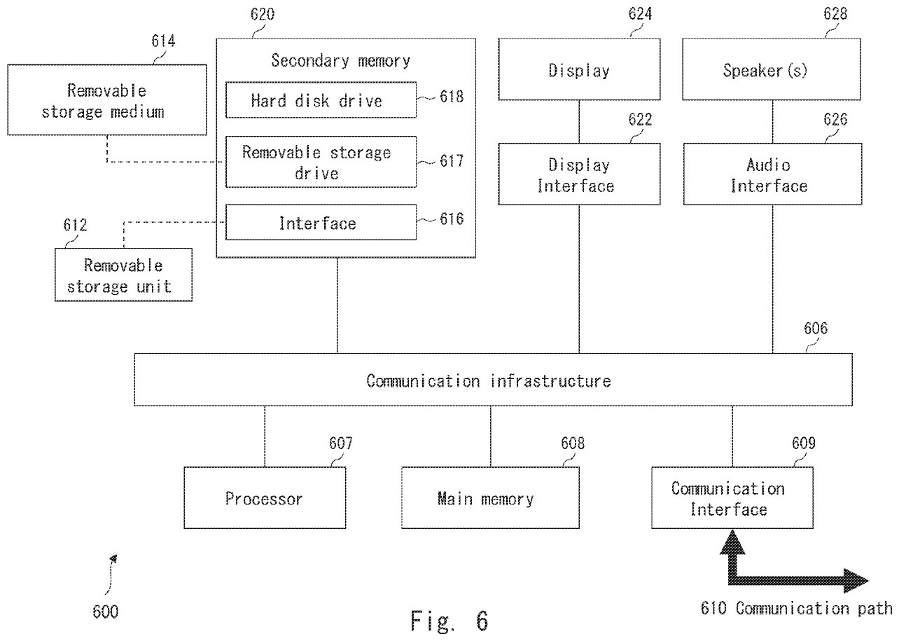

FIG. 6 depicts an exemplary computing device 600, hereinafter interchangeably referred to as a computer system 600, where one or more such computing devices 600 may be used to execute the method of FIG. 5. The exemplary computing device 600 can be used to implement the system 200, 500 shown in FIGS. 2 and 5.

The following description of the computing device 600 is provided by way of example only and is not intended to be limiting.

As shown in FIG. 6, the example computing device 600 includes a processor 607 for executing software routines. Although a single processor is shown for the sake of clarity, the computing device 600 may also include a multi-processor system. The processor 607 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 620. The secondary memory 620 may include, for example, a storage drive 617, which may be a hard disk drive, a solid state drive or a hybrid drive and/or a removable storage drive 617, which may include a magnetic tape drive, an optical disk drive, a solid state storage drive (such as a USB flash drive, a flash memory device, a solid state drive or a memory card), or the like. The removable storage drive 617 reads from and/or writes to a removable storage medium 614 in a well-known manner. The removable storage medium 614 may include magnetic tape, optical disk, non-volatile memory storage medium, or the like, which is read by and written to by removable storage drive 617. As will be appreciated by persons skilled in the relevant art(s), the removable storage medium 614 includes a computer readable storage medium having stored therein computer executable program code instructions and/or data.

In an alternative implementation, the secondary memory 620 may additionally or alternatively include other similar means for allowing computer programs or other instructions to be loaded into the computing device 600. Such means can include, for example, a removable storage unit 612 and an interface 616. Examples of a removable storage unit 612 and interface 616 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 612 and interfaces 616 which allow software and data to be transferred from the removable storage unit 612 to the computer system 600.

The computing device 600 also includes at least one communication interface 609. The communication interface 609 allows software and data to be transferred between computing device 600 and external devices via a communication path 610. In various embodiments of the inventions, the communication interface 609 permits data to be transferred between the computing device 600 and a data communication network, such as a public data or private data communication network. The communication interface 609 may be used to exchange data between different computing devices 600 which such computing devices 600 form part an interconnected computer network. Examples of a communication interface 609 can include a modem, a network interface (such as an Ethernet card), a communication port (such as a serial, parallel, printer, GPIB, IEEE 1394, RJ45, USB), an antenna with associated circuitry and the like. The communication interface 609 may be wired or may be wireless. Software and data transferred via the communication interface 609 are in the form of signals which can be electronic, electromagnetic, optical or other signals capable of being received by communication interface 609. These signals are provided to the communication interface via the communication path 610.

As shown in FIG. 6, the computing device 600 further includes a display interface 622 which performs operations for rendering images to an associated display 624 and an audio interface 626 for performing operations for playing audio content via associated speaker(s) 628.

As used herein, the term “computer program product” may refer, in part, to removable storage medium 614, removable storage unit 612, a hard disk installed in storage drive 618, or a carrier wave carrying software over communication path 610 (wireless link or cable) to communication interface 609. Computer readable storage media refers to any non-transitory, non-volatile tangible storage medium that provides recorded instructions and/or data to the computing device 600 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on

Websites and the like.

The computer programs (also called computer program code) are stored in main memory 608 and/or secondary memory 620. Computer programs can also be received via the communication interface 609. Such computer programs, when executed, enable the computing device 600 to perform one or more features of embodiments discussed herein. In various embodiments, the computer programs, when executed, enable the processor 607 to perform features of the above-described embodiments. Accordingly, such computer programs represent controllers of the computer system 600.

Software may be stored in a computer program product and loaded into the computing device 600 using the removable storage drive 617, the removable storage unit 612, or the interface 616. The computer program product may be a non-transitory computer readable medium. Alternatively, the computer program product may be downloaded to the computer system 600 over the communications path 610. The software, when executed by the processor 607, causes the computing device 600 to perform the necessary operations to execute the method 500 as shown in FIG. 5.

It is to be understood that the embodiment of FIG. 6 is presented merely by way of example to explain the operation and structure of the system 100. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated that the elements illustrated in FIG. 6 function to provide means for performing the various functions and operations of the servers as described in the above embodiments.

When the computing device 600 is configured to determine a contextual threshold, the computing system 600 will have a non-transitory computer readable medium having stored thereon an application which when executed causes the computing system 600 to perform steps comprising: identify an image of the first subject and the second subject in a frame within which the first subject and the second subject appear; identify multi-dimensional information relating to the first subject and the second subject based on the identified image; and determine the contextual threshold based on the identified multi-dimensional information relating to the first subject and the second subject.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

The present application is based upon and claims the benefit of priority from Singapore Patent Application No. 10202002676S, filed on Mar. 23, 2020, the entire contents of which are hereby incorporated by reference.

### REFERENCE SIGNS LIST

102 apparatus

104 processor

106 memory

110 image capturing device

600 computing device

606 communication infrastructure

607 processor

608 main memory

609 communication interface

610 communications path

612 removable storage unit

614 removable storage medium

616 interface

617 removable storage drive

618 storage drive (hard disk drive)

620 secondary memory

622 display interface

624 display

626 audio interface

628 speaker(s)

What is claimed is:

1. A method for determining a contextual threshold, the contextual threshold indicating a likelihood of connection between a first subject and a second subject, the method comprising:
identifying an image of the first subject and the second subject in a frame within which the first subject and the second subject appear;
identifying multi-dimensional information relating to the first subject and the second subject based on the identified image; and
determining the contextual threshold based on the identified multi-dimensional information relating to the first subject and the second subject.

2. The method according to claim 1, wherein the step of identifying the image of the first subject and the second subject in the frame within which the first subject and the second subject appear comprises:
performing face detection on two or more subjects in the frame;
extracting corresponding characteristics on each of the two or more subjects based on the performance; and
identifying the first subject and the second subject, the first subject and the second subject being ones that are suitable for determining the contextual threshold.

3. The method according to claim 1, wherein the step of identifying multi-dimensional information relating to the first subject and the second subject based on the identified image comprises:
retrieving at least one of head size, eye position and a length of an arm of each of the first subject and the second subject.

4. The method according to claim 3, wherein the step of identifying multi-dimensional information relating to the first subject and the second subject based on the identified image comprises:
determining an attention direction of each of the first subject and the second subject.

5. The method according to claim 4, wherein the attention direction of each of the first subject and the second subject is determined based on the retrieved at least one of head size and eye position of each of the first subject and the second subject.

6. The method according to claim 5, further comprising:
determining if the attention direction of each of the first subject and the second subject is towards each other; and
setting a threshold of two arms length between the first subject and the second subject when it is determined that the attention direction of each of the first subject and the second subject is towards each other.

7. The method according to claim 6, further comprising:
determining if the attention direction of at least one of the first subject and the second subject is towards the other one of the first subject and the second subject when it is determined that the attention direction of each of the first subject and the second subject is not towards each other; and
setting a threshold of one arms length between the first subject and the second subject when it is determined that the attention direction of at least one of the first subject and the second subject is towards the other one of the first subject and the second subject.

8. The method according to claim 7, further comprising:
setting a threshold of zero arms length between the first subject and the second subject when it is determined that the attention direction of at least one of the first subject and the second subject is not towards the other one of the first subject and the second subject.

9. The method of claim 6, wherein the contextual threshold is determined based on the threshold.

10. An apparatus for determining a contextual threshold, the contextual threshold indicating a likelihood of connection between a first subject and a second subject, the apparatus comprising:
at least one processor; and
at least one memory including computer program code;
the at least one memory and the computer program code configured to, with at least one processor, cause the apparatus at least to:
identify an image of the first subject and the second subject in a frame within which the first subject and the second subject appear;
identify multi-dimensional information relating to the first subject and the second subject based on the identified image; and
determine the contextual threshold based on the identified multi-dimensional information relating to the first subject and the second subject.

11. The apparatus according to claim 10, wherein the at least one memory and the computer program code configured to, with at least one processor, cause the apparatus at least to:
perform face detection on two or more subjects in the frame;
extract corresponding characteristics on each of the two or more subjects based on the performance; and
identify the first subject and the second subject, the first subject and the second subject being ones that are suitable for determining the contextual threshold.

12. The apparatus according to claim 10, wherein the at least one memory and the computer program code configured to, with at least one processor, cause the apparatus at least to:
retrieve at least one of head size, eye position and a length of an arm of each of the first subject and the second subject.

13. The apparatus according to claim 12, wherein the at least one memory and the computer program code configured to, with at least one processor, cause the apparatus at least to:
determine an attention direction of each of the first subject and the second subject.

14. The apparatus according to claim 13, wherein the attention direction of each of the first subject and the second subject is determined based on the retrieved at least one of head size and eye position of each of the first subject and the second subject.

15. The apparatus according to claim 12, wherein the at least one memory and the computer program code configured to, with at least one processor, cause the apparatus at least to:
determine if the attention direction of each of the first subject and the second subject is towards each other; and
set a threshold of two arms length between the first subject and the second subject when it is determined that the attention direction of each of the first subject and the second subject is towards each other.

16. The apparatus according to claim 15, wherein the at least one memory and the computer program code configured to, with at least one processor, cause the apparatus at least to:
determine if the attention direction of at least one of the first subject and the second subject is towards the other one of the first subject and the second subject when it is determined that the attention direction of each of the first subject and the second subject is not towards each other; and
set a threshold of one arms length between the first subject and the second subject when it is determined that the attention direction of at least one of the first subject and the second subject is towards the other one of the first subject and the second subject.

17. The apparatus according to claim 16, wherein the at least one memory and the computer program code configured to, with at least one processor, cause the apparatus at least to:
set a threshold of zero arms length between the first subject and the second subject when it is determined that the attention direction of at least one of the first subject and the second subject is not towards the other one of the first subject and the second subject.

18. The apparatus of claim 15, wherein the contextual threshold is determined based on the threshold.

19. A non-transitory computer readable medium storing computer program code for determining a contextual threshold, the contextual threshold indicating a likelihood of connection between a first subject and a second subject, for causing a computer at least to:
identify an image of the first subject and the second subject in a frame within which the first subject and the second subject appear;
identify multi-dimensional information relating to the first subject and the second subject based on the identified image; and
determine the contextual threshold based on the identified multi-dimensional information relating to the first subject and the second subject.
